(19) United States
(12) Patent Application Publication
(10) Pub. No.: US 2017/0270816 A1
(43) Pub. Date: Sep. 21, 2017

(54) Board Game and Method of Play

(71) Applicant: Jerry Thompson, Castle Rock, CO (US)

(72) Inventor: Jerry Thompson, Castle Rock, CO (US)

(21) Appl. No.: 15/137,574

(22) Filed: Apr. 25, 2016

Related U.S. Application Data
(60) Provisional application No. 62/310,042, filed on Mar. 18, 2016.

(51) Int. Cl. G09B 19/00; A63F 3/00

(52) U.S. Cl. CPC G09B 19/00; A63F 3/00006; A63F 2003/00009

(57) ABSTRACT

A board game and method of play having a Noah's ark theme. The board game includes a game board having a starting space and a finish space, wherein a plurality of paths having spaces therealong connect the starting space and the finish space. One or more of the spaces include instructions thereon for the player to follow, wherein the instructions dictate the course of gameplay. Each player receives at least one pair of game pieces, wherein the game pieces are preferably pairs of animals. The user positions a first game piece of each pair in a player order zone that indicates the order of gameplay. The users take turns rolling dice to move their second game pieces from the starting space to the finish space. The players must move all of their game pieces to the finish line before any other player in order to win.

### CROSS REFERENCE TO RELATED APPLICATION

This application claims the benefit of U.S. Provisional Application No. 62/310,042 filed on Mar. 18, 2016. The above identified patent application is herein incorporated by reference in its entirety to provide continuity of disclosure.

### BACKGROUND OF THE INVENTION

### Field of the Invention

The present invention relates to board games. More specifically, the present invention provides a Noah's ark themed board game, wherein players are assigned at least one pair of game pieces and take turns rolling dice to move their game pieces along a path in order to be the first to move their game pieces from a starting space to a finish space.

Board games are a popular family-friendly activity that allows people of all ages to spend time together and participate in a common activity. Parents can play board games in order to play and interact with their children, and to occupy the children to keep them entertained. While most board games are simply for fun and serve as a leisure activity, it is often desirable to play a board game that is instructional or educational.

Children's board games can be used as an educational tool for teaching children how to take turns, follow instructions, play fairly, and keep a positive attitude. However, board games that rely solely on luck or chance and do not help the players to learn any of these important skills. Thus, the present invention aims to provide a board game that helps children to learn to play together and follow instructions in an entertaining manner.

Devices have been disclosed in the prior art that relate to board games and methods of playing board games. These include devices that have been patented and published in patent application publications. These devices generally relate to board games having various rules and playing surfaces, such as U.S. Pat. No. 887,464, U.S. Published Patent Application Number 2010/0276883, U.S. Pat. No. 7,396,014, U.S. Pat. No. 6,698,760, U.S. Published Patent Application Number 2005/0133996, and U.S. Pat. No. 5,067,722.

These prior art devices have several known drawbacks. The games in the prior art do not allow the player to travel along various paths between the starting space and the finish space and instead provide a single path that the player's must follow. This can become tedious and results in less variety of gameplay which may cause players to become bored with the game after several rounds of playing the board game. Further, the games in the prior art do not require the player to simultaneously play with multiple game pieces, such that the player must move all of his or her game pieces to the finish space.

In light of the devices disclosed in the prior art, it is submitted that the present invention substantially diverges in design elements from the prior art and consequently it is clear that there is a need in the art for an improvement to existing board game devices and methods of play. In this regard the instant invention substantially fulfills these needs.

### SUMMARY OF THE INVENTION

In view of the foregoing disadvantages inherent in the known types of board games now present in the prior art, the present invention provides a new board game wherein the same can be utilized for providing convenience for the user when playing a board game with people of various ages that provides educational benefits for children.

The present invention provides a board game and method of play comprising a game board having a starting space, a finish space, and a plurality of paths connecting the starting space and the finish space. Each player is provided with at least one pair of game pieces, wherein the game pieces preferably resemble animals. A first game piece of each pair is positioned in a player order zone, wherein the player order zone indicates the order of play such that each game piece receives a turn. The second game piece of each pair is used to move around the paths, wherein the players roll die in order to determine the number of spaces their game piece must be moved. One or more spaces are action spaces that include instructions thereon that the user must follow before completing their turn or upon the start of their next turn.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the game board of the present invention.

FIG. 2 shows a flow chart of a method of play of the board game of the present invention.

FIG. 3 shows a flow chart of a player's turn of the board game of the present invention.

### DETAILED DESCRIPTION OF THE INVENTION

Reference is made herein to the attached drawings. Like reference numerals are used throughout the drawings to depict like or similar elements of the board game. For the purposes of presenting a brief and clear description of the present invention, the preferred embodiment will be discussed as used for playing a board game with two or more players. The figures are intended for representative purposes only and should not be considered to be limiting in any respect.

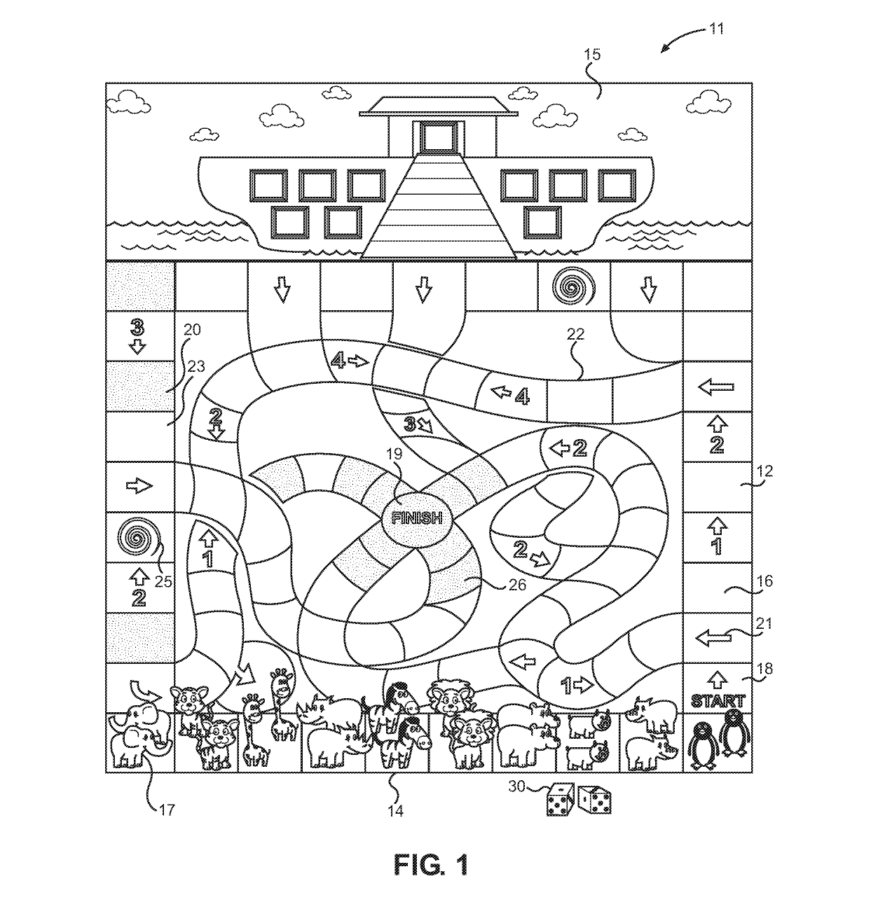

Referring now to FIG. 1, there is shown a front view of an embodiment of the game board of the present invention. The board game 11 comprises a game board 12, at least one pair of game pieces 17 assigned to each player, and a random number generator 30. The random number generator 30 is preferably, one or more die, such as six-sided die having numerals one through six on the faces thereof. However, in alternate embodiments, the random number generator can include die having more or less than six sides, a spinner, or the like. While it is understood that various types of random number generators 30 can be used consistent with the purpose and intent of the present invention, the random number generator will hereinafter be referred to simply as “die” or “dice.” The game pieces 17 are preferably pairs of animals, such as dogs, goats, cows, pigs, horses, tigers, and zebras, among any of various other types of animals.

The game board 12 comprises a flat, rectangular panel having an upper surface that serves as the playing surface. The game board 12 comprises a plurality of spaces 16 forming a plurality of paths that extend between a starting space 18 and a finish space 19 so as to provide different routes by which a player may reach the finish space 19. The game board 12 further comprises a player order zone 14 and a finish zone 15.

The player order zone 14 indicates the order in which the game pieces are moved. The player order zone 14 is preferably located at the lower end of the game board 12 and includes a plurality of spaces arranged from left to right. In the illustrated embodiment, the player order zone 14 includes ten spaces. The players can arrange the various game pieces such that one game piece from each pair of game pieces being used in the game is in each space. Play proceeds by starting with the first or leftmost space in the player order zone and moves along the player order zone from the first space to the tenth or final space, such that each game piece is provided with a turn before any game piece has a second or subsequent turn. The player order zone 14 helps players to keep track of which game piece moves next which may otherwise be difficult since each player is playing with multiple game pieces.

The game board 12 further includes a finish zone 15 that serves as a place for players to position their game pieces once the game pieces have reached the finish space 19. The finish zone 15 helps to clear game pieces from the finish space 19 so that the finish space 19 does not become overcrowded and also helps to allow players to more easily identify which players have reached the finish space 19 with one or more of their game pieces.

The plurality of paths on the game board comprises an outer path 23 and an inner path 22. The outer path 23 extends around a portion of the perimeter of the game board 12, and preferably along three sides of the game board 12. A plurality of inner paths 22 connect the outer path 23 to the finish space 19, so as to provide a variety of routes by which the players may reach the finish space 19. Preferably, the inner paths 22 extend from various portions of the outer path 23 towards the finish space 19. Players must follow different rules depending upon whether the player's game pieces are positioned on the outer path 23 or the inner path 22.

One or more spaces 16 on the game board 12 are safe spaces and include no instructions thereon. One or more spaces 16 on the game board 12 are action spaces 20 and provide an instruction that the player must follow if his or her game piece lands thereon. Action spaces 20 include but are not limit to, a reverse space that provides the instruction that the game piece must travel in the opposite direction on their next turn. A “lose a turn” space is provided that causes the game piece to have to miss the next turn. A whirlpool 25 space is provided wherein the whirlpool 25 space allows the game piece that lands thereon to travel to a second whirlpool 25 space located in another location of the game board 12, which may function as a shortcut towards the finish space. A pair of typhoon spaces may further be included wherein the typhoon spaces function similarly to the whirlpool space 25. A direction space indicates the direction the player must travel on his or her next turn when the player has reached a fork in the path. For example, the direction space may indicate that the user can proceed to the inner path from the outer path on the following turn. Move ahead or move backward spaces are provided, wherein these spaces provide the instruction that the player must move forward or backward a set number of spaces before completing his or her turn. A “swap spaces” space indicates that the game piece that lands thereon must exchange spaces with another game piece that has not yet reached the finish space 19. Additional action spaces 20 may be provided to add further interest and variety to the game.

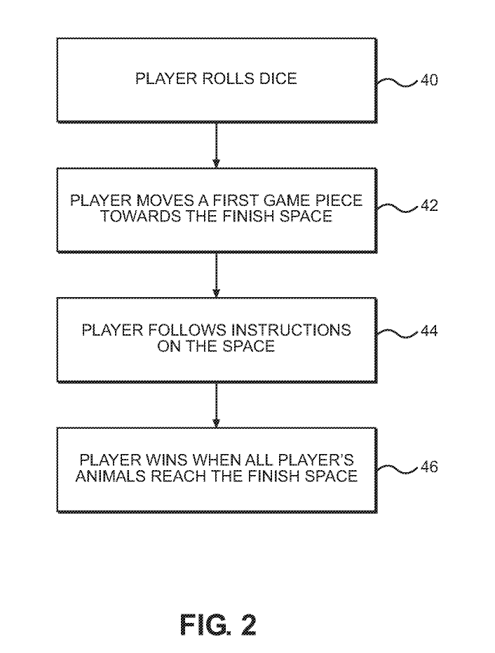

Referring now to FIG. 2, there is shown a flow chart of a player's turn. In a preferred embodiment, there are ten pairs of game pieces for use by two or more players. The game pieces are distributed to the players such that each player has the same number of game pieces. Thus, if two players are playing, each player receives five pairs of game pieces. If three players are playing, each player receives three pairs of game pieces, wherein the tenth pair of game pieces is not used.

One game piece from each pair of game pieces is arranged in the player order zone. The player order zone is used to keep track of the order of play. One game piece is positioned in each space of the player order zone. The game piece remains in the player order zone until the second game piece of the pair reaches the finish zone, at which point the matching game piece in the player order zone is also moved to the finish zone. The user's second game piece from each of their pairs of game pieces is used to move around the board.

Each player takes a turn rolling a die or dice 40 in order to move his or her game piece along the path. The number rolled on the die or dice corresponds to the number of spaces the player must move his or her game piece 42 along the path towards the finish space. If the game piece lands on an instruction space, the player must follow the instruction 44 and then finish his or her turn. Multiple game pieces may be positioned on a single space on the game board. Thus a first player's game piece and a second player's game piece can occupy the same space simultaneously. A player wins if he or she is the first to have all of his or her game pieces reach the finish space 46.

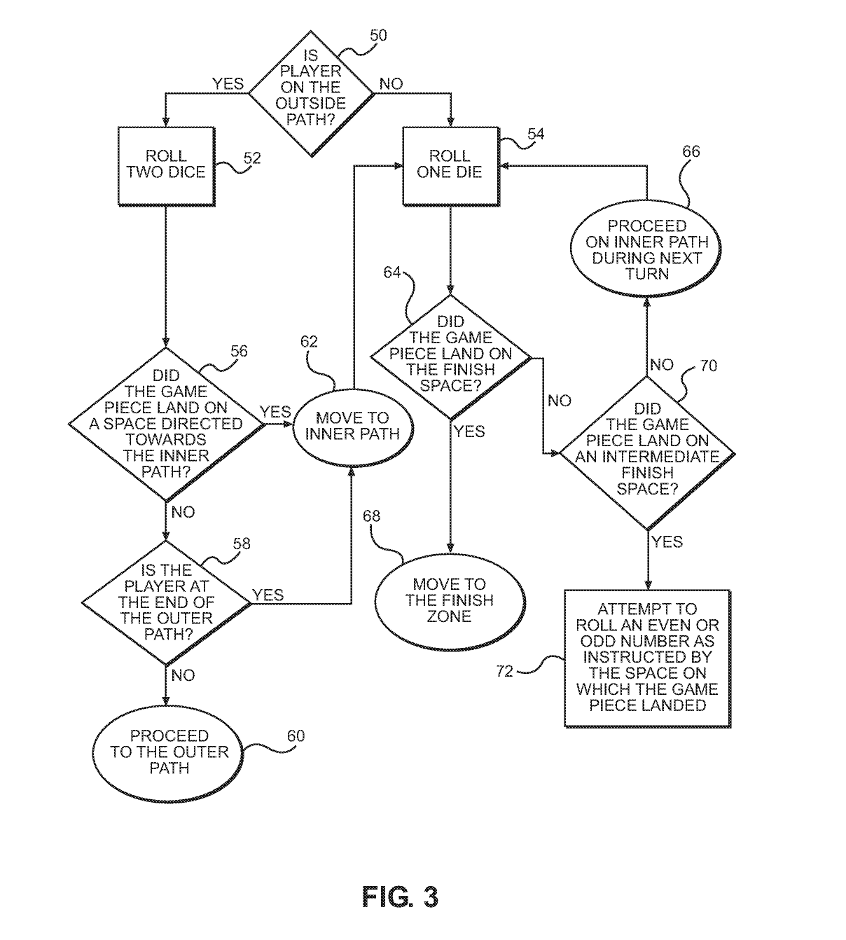

Referring now to FIG. 3, there is shown a flowchart of the method of gameplay. If a player is on the outer path 50, the player rolls a pair of dice on his or her turn 52. The player then moves his or her game piece the corresponding number of spaces along the outside path. In order to access the inner path and move towards the finish space, the player's game piece must land on a space on the outer path that directs the user to proceed into the inner path on his or her next turn 56. If the player reaches the last space on the outer path 58, the player can automatically proceed to the inner path 62. Otherwise, the player must continue along the outer path 60 until the player lands on a space that directs the player to the inner path or until the player reaches the end of the outer path. In this way, some players may enter the inner path sooner than others if they land on a space that allows them to do so. Otherwise, all players will eventually move into the inner path by reaching the end of the outer path.

If the player begins a turn with his or her game piece on a space of the inner path, the player must roll only a single die 54 and move his or her piece the corresponding number of spaces. The player must travel in a single direction and cannot change directions. However, some action spaces may indicate that the player must move his or her game piece backwards a fixed number of spaces or that the player must proceed in the opposite direction for the following turn.

In order to reach the finish, the player must land exactly on the finish space 64. If the player rolls a number that causes his or her piece to travel beyond the finish space, the player must reverse direction on the next turn and the player continues to roll the die on subsequent turns and move his or her game piece until he or she lands directly on the finish space 66. If the player lands on the finish space 64 the player moves his or her piece to the finish zone 68. Further, the spaces directly adjacent to the finish space are intermediate finish spaces. If the player lands on an intermediate finish space 70, the player must remain on that space in subsequent turns until the player is able to complete a specific task, such as roll an even number or an odd number 72, before moving to the finish zone 15.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A board game, comprising:
a game board having a starting space and a finish space, wherein the starting space and the finish space are connected via a plurality of paths each having a plurality of spaces therealong;
wherein one or more of the plurality of spaces include instructions thereon, wherein the instructions describe actions to be taken by a player;
a plurality of pairs of game pieces assigned to each player for use in moving along any of the plurality of paths;
a random number generator for randomly determining a number of spaces which a player must move a game piece along one of the plurality of paths.

2) The board game of claim 1, wherein the plurality of paths comprises an outer path extending about a perimeter of the game board and a plurality of inner paths extending from the outer path to the finish space.

3) The board game of claim 1, wherein the game board further comprises a player order zone that indicates an order of play, wherein the order of play provides each pair of game pieces with a turn.

4) A method of playing a board game, comprising the steps of:
providing a game board having a starting space and a finish space, wherein the starting space and the finish space are connected via a plurality of paths each having a plurality of spaces therealong;
providing each of a plurality of players with at least one pair of game pieces, wherein each pair of game pieces includes a first game piece and a second game piece;
positioning the first game piece of each pair of game pieces in a player order zone that indicates the order in which the game pieces are moved;
rolling die to determine the number of spaces a player must move the second game piece along the plurality of paths towards the finish space;
moving the second game piece the number of spaces as indicated by the die;
following instructions provided on the plurality of spaces.

5) The method of playing a board game of claim 1, wherein the game board comprises an outer path and an inner path, and wherein the step of rolling the die includes the step of:
rolling a pair of die if the game piece is positioned on the outer path.
